(19) United States
(12) Patent Application Publication
(10) Pub. No.: US 2025/0254236 A1
(43) Pub. Date: Aug. 7, 2025

(54) ELECTRONIC DEVICE CAPABLE OF FACILITATING CONTROL FRAME TRANSMISSION AND METHOD THEREFOR

(71) Applicant: SK hynix Inc., Icheon-si Gyeonggi-do (KR)

(72) Inventor: Shao Chun KAN, Zhubei City Hsinchu County (TW)

(73) Assignee: SK hynix Inc., Icheon-si Gyeonggi-do (KR)

(21) Appl. No.: 18/591,895

(22) Filed: Feb. 29, 2024

(30) Foreign Application Priority Data
Feb. 1, 2024 (TW) 113103903

(51) Int. Cl. H04L 69/321

(52) U.S. Cl. CPC H04L 69/321

(57) ABSTRACT

Electronic device and method to facilitate control frame transmission are provided. The electronic device comprises an interconnection controller including a physical layer circuit for signal transmission, a signaling interface, a link controller coupled to the physical layer circuit through the signaling interface, and a bypass path coupled to the link controller for control frame transmission. The link controller is configured to transmit data to the physical layer circuit through the signaling interface, and to transmit a control frame to the physical layer circuit through a signal path including the bypass path to bypass at least one circuit stage of the link controller.

### CROSS-REFERENCE TO RELATED APPLICATION

This non-provisional application claims priority under 35 U.S.C. § 119(a) to Taiwanese Patent Application No. 113103903 filed on Feb. 1, 2024, in the Taiwan Intellectual Property Office, the entire contents of which are hereby incorporated by reference.

### BACKGROUND OF THE INVENTION

### 1. Field of the Invention

The present disclosure relates to circuit, controllers, and methods for frame transmission for an electronic device, and in particular to circuits, controllers, and methods for frame transmission for an interconnection protocol, and an electronic device.

### 2. Description of the Related Art

The Mobile Industry Processor Interface (MIPI) alliance developed interconnection protocol technology, for example, MIPI M-PHY specification associated with a physical layer and MIPI UniPro specification associated with a Unified Protocol (UniPro), for interconnection from one chip to another inside the mobile devices or those affected by the mobile devices in order to implement higher transmission speeds and low power consumption operations. On the other hand, the Joint Electron Device Engineering Council (JEDEC), using the MIPI M-PHY specification and the MIPI UniPro specification, launched a high-performance non-volatile memory standard that is referred to as Universal Flash Storage (UFS). The UFS standard realizes gigabit-level high-speed transmissions and low-power operations, and provides the functionality and expandability required for advanced mobile systems (for example, computing devices such as smartphones, tablet computers, multimedia devices, and wearable devices) to facilitate rapid adoption by the industry.

A system implemented according to the UFS standard or UniPro specification includes a local host (e.g., a computing device or chip) and a remote device (e.g., a storage device or another chip). A bidirectional link is established between the host and the device, and this link can be configured with one or multiple lanes in either of the transmission directions. According to the UniPro specification (such as UniPro version 2.0), link-level flow control is used in a data link (DL) layer of the protocol stack of the UniPro specification. Data link layer flow control ensures that the transmitting end knows how much buffer space is available at the data link layer of the receiving end of the Link. A credit-based flow control mechanism is used whereby the receiving end transmits credit information (in the form of Acknowledgment and Flow Control (AFC) frames) to update credit information maintained at the transmitting end.

According to the UniPro specification, the AFC frame for data link layer is used for acknowledging correctly received data frames and for exchanging flow control information of a corresponding traffic class. A Negative Acknowledgment Control (NAC) frame for data link layer is transmitted when a receiver of the receiving end detects an error in any frame or if a data frame (or called DL data) is received with a wrong frame sequence number or if the reverse link needs to be reinitialized.

In digital circuits, a pipeline involves parallelizing operations to optimize resource utilization, enhancing overall throughput. The UniPro layers can be designed to run efficiently as a pipelined hardware implementation. However, the introduction of a pipeline to improve throughput can inadvertently lead to increased latency in the transmission of DL control frames such as AFC or NAC frames. Given the impact of the latency on bandwidth usage and performance, there is a need to reduce latency for the DL control frames. Attempting to address pipeline latency by reducing pipeline levels may result in setup time violations, especially with a high clock frequency. Setup time violation refers to the duration during which input data must remain stable before the clock's triggering edge and data changing within this setup time window can lead to data loss and metastability issues. Despite the advantages of pipelined architectures, reducing latency, particularly in terms of clock cycles, proves to be a challenging task.

### BRIEF SUMMARY OF THE INVENTION

In the present disclosure, technologies for facilitating control frame transmission for an interconnection protocol are provided, and are suitable for an electronic device capable of communicating with another electronic device according to the interconnection protocol.

Embodiments of an electronic device configured to facilitate control frame transmission are provided. The electronic device comprises an interconnection controller including a physical layer circuit for signal transmission, a signaling interface, a link controller coupled to the physical layer circuit through the signaling interface, and a bypass path coupled to the link controller for control frame transmission. The link controller is configured to transmit data to the physical layer circuit through the signaling interface, and to transmit a control frame to the physical layer circuit through a signal path including the bypass path to bypass at least one circuit stage of the link controller.

Embodiments of a method for facilitating control frame transmission for use in an electronic device are provided. The method comprising following steps: transmitting data from a link controller of the electronic device to a physical layer circuit of the electronic device through a signaling interface; and transmitting a control frame from the link controller to a physical layer circuit through a signal path including a bypass path coupled to the link controller for control frame transmission to bypass at least one circuit stage of the link controller.

In some embodiments of the method or the electronic device, the link controller is configured to transmit the control frame to the physical layer circuit directly through the bypass path.

In some embodiments of the method or the electronic device, the link controller is configured to transmit the control frame directly from a pipelined circuit of the link controller to the physical layer circuit through the bypass path.

In some embodiments of the method or the electronic device, the link controller is configured to transmit the control frame directly from a pipelined circuit of the link controller to the physical layer circuit through the bypass path to bypass at least one circuit stage between the pipelined circuit of the link controller and the physical layer circuit.

In some embodiments of the method or the electronic device, the link controller is configured to transmit the control frame directly from a data link layer of the link controller to the physical layer circuit through the bypass path.

In some embodiments of the method or the electronic device, the link controller is configured to transmit the control frame directly to the physical layer circuit through the bypass path to bypass a physical adapter layer of the link controller.

In some embodiments of the method or the electronic device, the link controller is configured to transmit the control frame to the physical layer circuit directly through the bypass path, and the physical layer circuit is configured to, in response to the control frame, transmit a control information signal based on the control frame and pause signal transmission which is based on the data received through the signaling interface.

In some embodiments of the method or the electronic device, the physical layer circuit is configured to transmit the control information signal based on the control frame and pause the signal transmission which is based on the data received through the signaling interface in response a control signal associated with the control frame received through the bypass path.

In some embodiments of the method or the electronic device, the physical layer circuit is configured to proceed with the signal transmission which is based on the data received through the signaling interface after transmitting the control information signal based on the control frame.

In some embodiments of the method or the electronic device, the control information signal includes information based on the control frame and information based on a control symbol of continuation of preempted frame (COF).

In some embodiments of the method or the electronic device, the bypass path is coupled between a circuit stage of the link controller and the signaling interface.

In some embodiments of the method or the electronic device, the link controller is configured to transmit the control frame from a pipelined circuit of the link controller to the physical layer circuit through the signal path including the bypass path and the signaling interface.

In some embodiments of the method or the electronic device, the link controller is configured to transmit the control frame from a pipelined circuit of the link controller to the physical layer circuit through the signal path including the bypass path and the signaling interface to bypass at least one circuit stage between the pipelined circuit of the link controller and the signaling interface.

In some embodiments of the method or the electronic device, the bypass path is connected between a data link layer of the link controller and an interfacing module of a physical adapter layer of the link controller, and the interfacing module is connected to the signaling interface.

In some embodiments of the method or the electronic device, the link controller is configured to transmit the control frame from the data link layer of the link controller to the physical layer circuit through the signal path including the bypass path and the signaling interface.

In some embodiments of the method or the electronic device, the link controller is configured to transmit the control frame to the physical layer circuit through the signal path including the bypass path and the signaling interface to bypass a physical adapter layer entity of a physical adapter layer of the link controller.

In some embodiments of the method or the electronic device, the control frame is an acknowledgment and flow control (AFC) frame or a negative acknowledgment control (NAC) frame based on a Unified protocol (UniPro).

Accordingly, the above embodiments can facilitate control frame transmission, thereby reducing latency in control frame transmission.

### BRIEF DESCRIPTION OF THE DRAWINGS

FIG. 1 is a block diagram illustrating an embodiment of a communication system capable of communication according to an interconnection protocol.

FIG. 2 is a block diagram illustrating an embodiment of a device including an interconnection controller which includes a link controller and a physical layer circuit.

FIG. 3 is a block diagram illustrating another embodiment of a device including an interconnection controller which includes a link controller and a physical layer circuit.

FIG. 4 is a schematic diagram illustrating an embodiment of a pipelined-based architecture of an interconnection controller based on FIG. 2.

FIG. 5A is a schematic diagram illustrating an example of frame transmission with using bypass paths for AFC frame transmission.

FIG. 5B is a schematic diagram illustrating an example of frame transmission without using bypass paths for AFC frame transmission.

FIG. 6A is a schematic diagram illustrating an example of frame transmission with using bypass paths for NAC frame transmission.

FIG. 6B is a schematic diagram illustrating an example of frame transmission without using bypass paths for NAC frame transmission.

FIG. 7 is a block diagram illustrating an embodiment of a device based on FIG. 2 with respect to a bypass path connected between a link controller and a physical layer circuit.

FIG. 8 is a flowchart illustrating an embodiment of a method for facilitating control frame transmission.

FIG. 9 is a flowchart illustrating an embodiment of a method for facilitating control frame transmission.

FIG. 10A is a block diagram illustrating an embodiment of a circuit based on FIG. 2 with respect to a bypass path.

FIG. 10B is a block diagram illustrating an embodiment of a circuit based on FIG. 2 with respect to a bypass path connected between a link controller and a physical layer circuit.

FIG. 11A is a diagram illustrating circuit architecture of a storage system for an interconnection protocol according to an embodiment of the present disclosure.

FIG. 11B is a block diagram illustrating circuit architecture applicable to the controller in FIG. 11A for the interconnection protocol according to an embodiment of the present disclosure.

FIG. 11C is a block diagram illustrating circuit architecture applicable to the controller in FIG. 11A for the interconnection protocol according to an embodiment of the present disclosure.

FIG. 12 is a schematic diagram of an embodiment of a layered structure of the storage system in FIG. 11A according to the interconnection protocol.

FIG. 13 is a schematic diagram of an example of an AFC frame structure.

FIG. 14 is a schematic diagram of an example of a NAC frame structure.

FIG. 15 is a schematic diagram of an embodiment of a data frame preempted by a control frame through a bypass path.

### DETAILED DESCRIPTION OF THE INVENTION

To facilitate understanding of the object, characteristics and effects of this present disclosure, embodiments together with the attached drawings for the detailed description of the present disclosure are provided.

In the present disclosure, technologies for facilitating control frame transmission are provided, and are suitable for an electronic device capable of communicating with another electronic device according to an interconnection protocol. Embodiments of a device and a method for facilitating control frame transmission are provided. By using the technologies, control frame transmission can be performed more effectively and more efficiently by using a signal path to bypass at least one circuit stage of a link controller, thereby reducing latency in control frame transmission and enhancing performance.

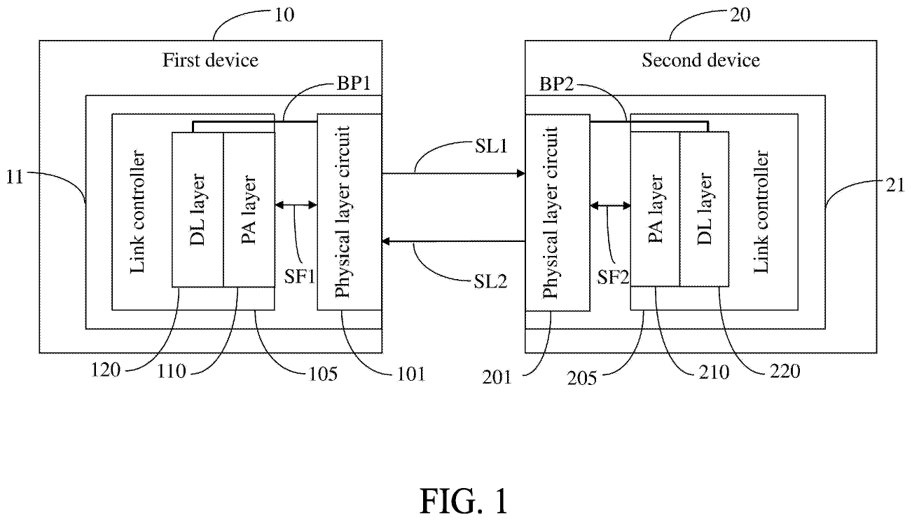

FIG. 1 is a block diagram illustrating an embodiment of a communication system capable of communication according to an interconnection protocol. The interconnection protocol may be based on a UniPro specification, a UFS system, or other related communication protocols or specifications, and so on, whenever appropriate. The communication system, for example, includes a first device 10 and a second device 20, which can be a local host and a remote device respectively, or vice versa. In FIG. 1, the first device 10 includes a physical layer circuit 101 for signal transmission and a link controller 105, which may be implemented as an interconnection controller 11. Likewise, the second device 20 includes a physical layer circuit 201 for signal transmission and a link controller 205, which may be implemented as an interconnection controller 21. The link controller 105 of the first device 10 for example implements a protocol layer of the interconnection protocol (or “link layer,” with respect to the physical layer such as M-PHY) such as a modified UniPro layer including such as a physical adapter (PA) layer 110, a data link (DL) layer 120, and so on. Likewise, the link controller 205 of the second device 20 for example also implements the protocol layer (or “link layer”) such as a modified UniPro layer including such as a physical adapter (PA) layer 210, a data link (DL) layer 220, and so on. The first device 10 is capable of communicating with the second device 20 through a link including at least one data lane SL1 and at least one data lane SL2, which are bidirectional, according to the interconnect protocol. For example, the interconnection protocol is applicable to a wide range of device types (e.g., for first device or second device) such as application processors, co-processors, modems, storage subsystems including non-volatile memory modules, displays, camera sensors, 3D graphics and multimedia accelerators, chips, and so on. It is also applicable to different types of data traffic such as control messages, bulk data transfer and packetized streaming. Other related MIPI alliance specifications or other related specifications can also be used for implementation of the physical layer or application layer, whenever appropriate.

As illustrated in FIG. 1, the first device 10 (or second device 20) further comprises a signaling interface SF1 (or SF2) and a bypass path BP1 (or BP2). The link controller 105 (or 205) is coupled to the physical layer circuit 101 (or 201) through the signaling interface SF1 (or SF2). The bypass path BP1 (or BP2) is coupled to the link controller 105 (or 205) for control frame transmission. The link controller 105 (or 205) is configured to transmit data such as PA frames to the physical layer circuit 101 (or 201) through the signaling interface SF1 (or SF2), and to transmit a control frame to the physical layer circuit 101 (or 201) through a signal path including the bypass path BP1 (or BP2). Transmitting the control frame from the DL layer 120 (or 220) to the physical layer circuit 101 (or 201) through the signal path including the bypass path BP1 (or BP2) can bypass one or more circuit stages of the link controller 105 (or 205), such as circuit stages of the PA layer 110 (or 210), thereby speeding up the control frame transmission and reducing control frame transmission latency. In addition, the circuit architecture for an interconnection controller with a bypass path as shown in FIG. 1 or related modifications can be referred to as “cross layer” architecture.

For example, the signaling interface SF1 (or SF2) can be implemented as an interfacing module and an interface bus based on reference M-PHY module interface (RMMI) of the M-PHY specification (e.g., version 5.0) or other interface, as long as both the PA layer 110 (or 210) and the physical layer circuit 101 (or 201) adopt such interface and communicates through the interface consistently.

For example, the bypass path BP1 (or BP2) can be implemented as circuit modules and a bus as long as both the PA layer 110 (or 210) and the physical layer circuit 101 (or 201) consistently adopt such path for control frame transmission.

In some embodiments, the control frame can be an acknowledgment and flow control (AFC) frame or a negative acknowledgment control (NAC) frame based on a United protocol (UniPro)(e.g., version 2.0).

In some embodiments based on FIG. 1, the interconnection controller 11 (or 21) of the first device 10 (or second device 20) can be configured to enable or disable the bypass path. When the bypass path is enabled, the link controller 105 (or 205) can transmit control frames from its data link layer 120 (or 220) to its physical layer circuit 101 (or 201) through the signal path including a bypass path BP1 (or BP2). When the bypass path is disabled, the link controller 105 (or 205) can transmit the control frames to the physical layer circuit 101 (or 201) through the PA layer 110 (or 210) and the signaling interface SF1 (or SF2).

Various embodiments for facilitating control frame transmission for the interconnection protocol are provided below, speeding up the control frame transmission through the bypass path.

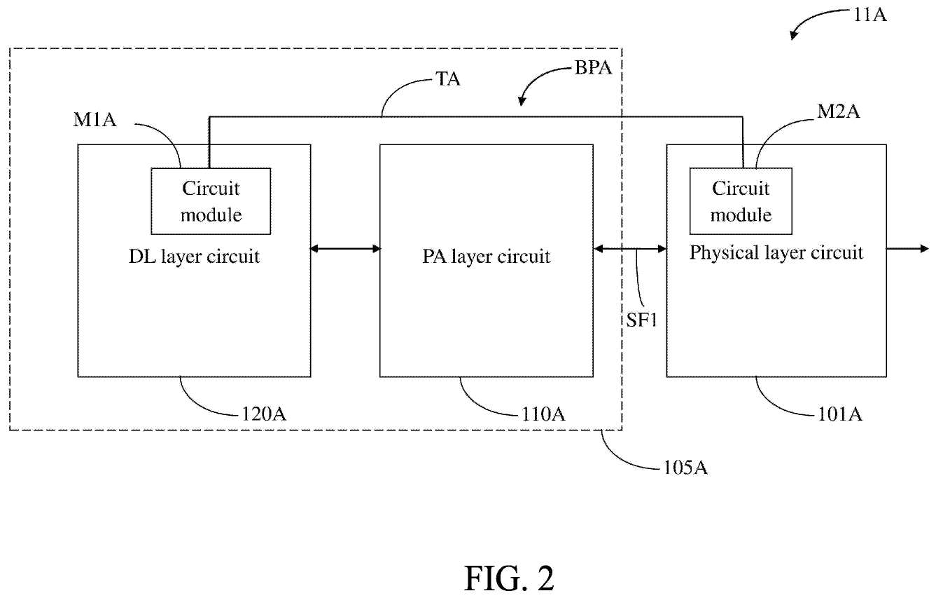

FIG. 2 is a block diagram illustrating an embodiment of a device including an interconnection controller which includes a link controller and a physical layer circuit. In FIG. 2, an interconnection controller 11A is shown with a bypass path BPA, providing an architecture for hardware implementation of an interconnection controller, which can be regarded as an embodiment of the interconnection controller 11 in FIG. 1 or can be applied to the implementation of the interconnection controller 21 in FIG. 1. The interconnection controller 11A includes a link controller 105A for implementing the protocol layer (or “link layer”) and a physical layer circuit 101A for signal transmission. The link controller 105A includes, for example, a physical adapter (PA) layer circuit 110A and a data link (DL) layer circuit 120A, and so on. In particular, the bypass path BPA is connected between a circuit stage of the link controller 105A and the physical layer circuit 101A. For example, the bypass path BPA includes a circuit module M1A in the DL layer circuit 120A, a bus TA including one or more lines or traces, and a circuit module M2A in the physical layer circuit 101A. The circuit module M1A is used for transmitting a control frame to the circuit module M2A in physical layer circuit 101A.

By using the architecture as illustrated in FIG. 2, the link controller 105A can be configured to transmit a control frame directly from the data link layer circuit 120A of the link controller 105A to the physical layer circuit 101A through the bypass path BPA as a signal path to bypass at least one circuit stage of the link controller 105A.

In FIG. 2, the link controller 105A is configured to transmit a control frame directly to the physical layer circuit 101A through the bypass path BPA to bypass a physical adapter layer circuit 110A of the link controller 105A.

In some embodiments based on FIG. 2, the link controller 105A is configured to transmit a control frame to the physical layer circuit 101A directly through the bypass path BPA, and the physical layer circuit 101A is configured to, in response to the control frame, transmit a control information signal based on the control frame and pause signal transmission which is based on the data received through the signaling interface SF1.

In some embodiments based on FIG. 2, the physical layer circuit 101A can be configured to transmit a control information signal based on the control frame and pause the signal transmission which is based on the data received through the signaling interface SF1 in response a control signal associated with the control frame received through the bypass path BPA. For example, the circuit module M1A transmits the control signal associated with the control frame to the circuit module M2A. In response to the control signal and the control frame, the circuit module M2A transmits a signal to request the physical layer circuit 101A to transmit the control information signal based on the control frame and pause the signal transmission which is based on the data received through the signaling interface SF1.

In some embodiments based on FIG. 2, the physical layer circuit 101A is configured to proceed with the signal transmission which is based on the data received through the signaling interface SF1 after transmitting the control information signal based on the control frame.

In some embodiments based on FIG. 2, the control information signal includes information based on the control frame and information based on a continuation of preempted frame (COF) control symbol. For example, the COF control symbol can be a control symbol that marks continuation of a preempted frame (e.g., a DL layer data frame) according to a UniPro specification (e.g., version 2.0). In an example based on FIG. 2, the circuit module M1A transmits a control frame (e.g., AFC or NAC frames) and a COF control symbol to the circuit module M2A. In response to the control frame and the COF control symbol, the circuit module M2A transmits a signal to request the physical layer circuit 101A to transmit the control information signal including information based on the control frame and information based on the COF control symbol. Compared to the preemption of a DL layer data frame done in a DL layer and associated data and control symbols transmitted to the PA layer, as described in the conventional UniPro specification (e.g., version 2.0), the present embodiments speed up transmitting a control frame by transmitting the control frame and the COF control symbol through the bypass path BPA to bypass the PA layer circuit 110A, and pausing signal transmission of data that the physical layer circuit 101A receives from the PA layer circuit 110A in the physical layer circuit 101A. In another example based on FIG. 2, the circuit module M1A transmits a control frame (e.g., AFC or NAC frames) and the circuit module M2A can be configured to receive the control frame and generate a COF control symbol, and then output the control frame and the COF control symbol to a circuit stage of the physical layer circuit 101A for signal transmission.

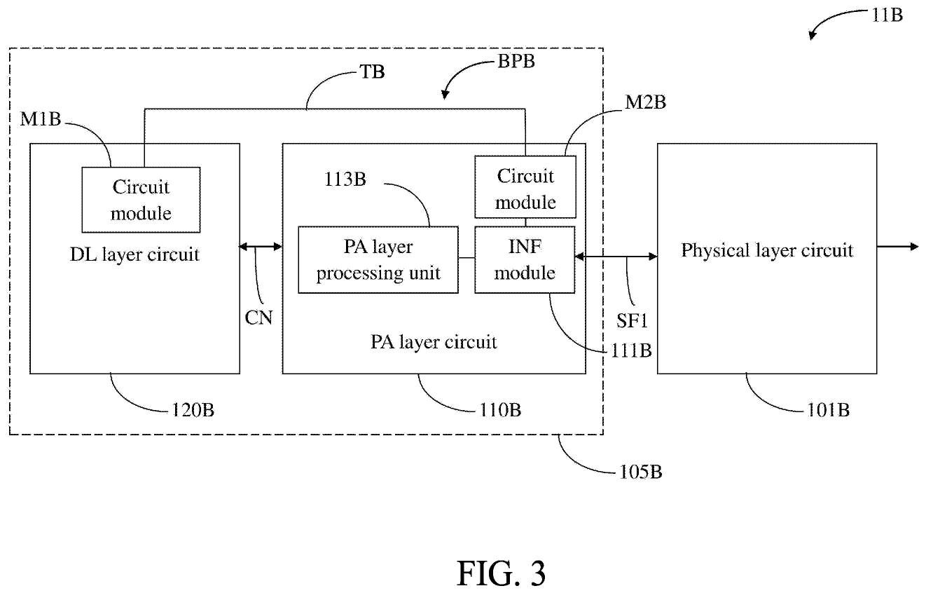

FIG. 3 is a block diagram illustrating another embodiment of a device including an interconnection controller which includes a link controller and a physical layer circuit. In FIG. 3, an interconnection controller 11B is shown with a bypass path BPB, providing another architecture of hardware implementation of an interconnection controller, which can be regarded as an embodiment of the interconnection controller 11 in FIG. 1 or can be applied to the implementation of the interconnection controller 21 in FIG. 1. The interconnection controller 11B includes a link controller 105B for implementing the protocol layer (or “link layer”) and a physical layer circuit 101B for signal transmission. The link controller 105B includes, for example, a physical adapter (PA) layer circuit 110B and a data link (DL) layer circuit 120B, and so on. In particular, the bypass path BPB is coupled between a circuit stage of the link controller 105B and the signaling interface SF1. For example, the bypass path BPB includes a circuit module M1B in the DL layer circuit 120B, a bus TB including one or more lines or traces, and a circuit module M2B in the PA layer circuit 110B. The circuit module M1B is used for transmitting a control frame to the circuit module M2B in the PA layer circuit 110B.

In some embodiments based on FIG. 3, the link controller 105B is configured to transmit a control frame from the DL layer circuit 120B (e.g., a pipelined circuit of the link controller 105B) to the physical layer circuit 101B through a signal path including the bypass path BPB and the signaling interface SF1.

In some embodiments based on FIG. 3, the link controller 105B is configured to transmit a control frame from the DL layer circuit 120B (e.g., a pipelined circuit of the link controller 105B) to the physical layer circuit 101B through a signal path including the bypass path BPB and the signaling interface SF1 to bypass one or more circuit stages between the DL layer circuit 120B (e.g., the pipelined circuit of the link controller 105B) and the signaling interface SF1.

In some embodiments based on FIG. 3, the bypass path BPB is connected between the data link layer circuit 120B of the link controller 105B and an interfacing (INF) module 111B of a physical adapter layer 110B of the link controller 105B. The interfacing module 111B is connected to the signaling interface SF1 and provides signals compliant with the signaling interface SF1 to output data of a physical adapter (PA) layer processing unit 113B connected to the interfacing (INF) module 111B.

In some embodiments based on FIG. 3, the link controller 105B is configured to transmit a control frame from the data link layer circuit 120B of the link controller 105B to the physical layer circuit 101B through a signal path including the bypass path BPB and the signaling interface SF1.

In some embodiments based on FIG. 3, the link controller 105B is configured to transmit a control frame to the physical layer circuit 101B through a signal path including the bypass path BPB and the signaling interface SF1 to bypass a physical adapter layer processing unit 113B of the physical adapter layer circuit 110B of the link controller 105B. The physical adapter layer processing unit 113B is for receiving input data (e.g., DL frames) from the DL layer circuit 120B and outputting output data (e.g., PA frames) to the physical layer circuit 101B based on the input data.

In some embodiments based on FIG. 3, the PA layer circuit 110B can be configured to, in response a control signal associated with a control frame received through the bypass path BPB, transmit the control frame received from the bypass pass BPB to the physical layer circuit 101B first and pause other data received from the DL layer circuit 120B through a circuit connection (e.g., denoted by CN, such as connection of registers or buffers between two pipelined circuits). For example, the circuit module M1B transmits the control signal associated with the control frame to the circuit module M2B. In response to the control signal and the control frame, the circuit module M2B transmits a signal to request the interfacing module 111B of the PA layer circuit 110B to transmit the control frame received from the bypass path BPB to the physical layer circuit 101B through the signaling interface SF1. In response, the interfacing module 111B transmits the control frame and pauses data transmission which is based on data received through a circuit connection CN between the PA layer circuit 110B and DL layer circuit 120B.

In some embodiments based on FIG. 3, the PA layer circuit 110B can be configured to proceed with data transmission which is based on the data received through the circuit connection CN after transmitting the control frame to the physical layer circuit 101B.

In some embodiments based on FIG. 3, the control frame and an associated control symbol of continuation of preempted frame (COF) are transmitted to the physical layer circuit.

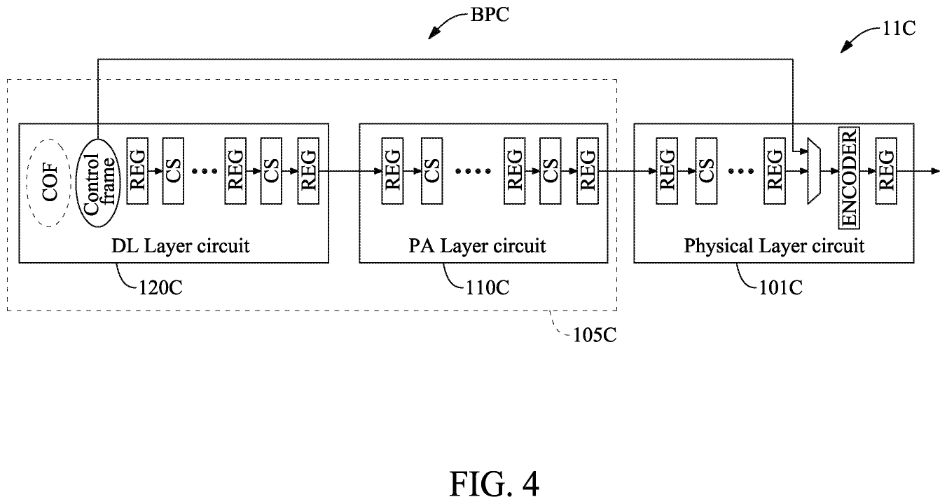

FIG. 4 is a schematic diagram illustrating an embodiment of a pipelined architecture of an interconnection controller based on FIG. 2. As shown in FIG. 4, an interconnection controller 11C based on FIG. 2 is shown with a bypass path BPC, providing a pipelined-based architecture of hardware implementation of an interconnection controller, which can be regarded as an embodiment of the interconnection controller 11 in FIG. 1 or can be applied to the implementation of the interconnection controller 21 in FIG. 1. The interconnection controller 11C includes a link controller 105C for implementing the protocol layer (or “link layer”) and a physical layer circuit 101C for signal transmission. The link controller 105C includes, for example, a physical adapter (PA) layer circuit 110C and a data link (DL) layer circuit 120C, and so on. In particular, the link controller 105C is configured to transmit a control frame directly from the DL layer circuit 120C of the link controller 105C to the physical layer circuit 101C through the bypass path BPC. The physical layer circuit 101C, physical adapter (PA) layer circuit 110C, and data link (DL) layer circuit 120C as shown in FIG. 4 are respective pipelined-based circuits, each of which includes a plurality of circuit stages (CS) and a plurality of registers (REG) regarding processing for the respective layer, such as the physical layer, the PA layer, or DL layer. In particular, in FIG. 4, the link controller 105C is configured to transmit a control frame such as an AFC or NAC frame directly from the DL layer circuit 120C to the physical layer circuit 101C through the bypass path BPC to bypass a number of circuit stages (including the registers among the circuit stages) between the DL layer circuit 120C and the physical layer circuit 101C. Specifically, for example, whenever generating a control frame such as an AFC or NAC frame, the DL layer circuit 120C can transmit the AFC or NAC frame immediately with a COF control symbol to a circuit module of the physical layer circuit 101C, such as a circuit module configured to receive the control frame, coupled between an encoder and a register of the physical layer circuit 101C. In this manner, several clocks of pipeline latency for the control frame can be saved and the control frame, whenever generated, can be transmitted to the physical layer circuit faster and earlier for signal transmission. In contrast to the embodiment of FIG. 4, the approach to reducing pipeline latency by reducing pipeline levels or increasing a clock frequency may result in setup time violations and difficult to realize.

Further, an embodiment of a pipelined architecture of an interconnection controller can be derived based on FIG. 3 to bypass at least one or more circuit stages of the PA layer circuit 110C.

According to the UniPro specification (e.g., version 2.0), some AFC frame transmission conditions are taken below as examples which are used to trigger the transmission of AFC frames with a credit transmit request (CReq) bit set to ‘0’, wherein an AFC frame can be generated for a specific traffic class such as traffic class 0 (TC0) or traffic class 1 (TC1). The DL layer transmits AFC frames when one of the conditions is satisfied. The AFC frame transmission will inevitably affect the performance of the entire communication system such as one shown in FIG. 1.

In an example of the AFC frame transmission conditions, an AFC frame is transmitted after reception of a NAC frame.

In an example of the AFC frame transmission conditions, before transmitting a NAC frame, if that NAC frame is not triggered by expiration of a flow control protection timer for a traffic class x (denoted by FCx_PROTECTION_TIMER as in the UniPro specification) or a replay timer for a traffic class x (denoted by TCx_REPLAY_TIMER as in the UniPro specification), an AFC frame is transmitted. In this example, the DL layer is required to be able to receive AFC frames before a NAC frame.

In an example of the AFC frame transmission conditions, an AFC frame is transmitted after TCx_REPLAY_TIMER has expired.

In an example of the AFC frame transmission conditions, an AFC frame is transmitted after an AFC request timer for a traffic class x (denoted by AFCx_REQUEST_TIMER as in the UniPro specification) has expired.

In an example of the AFC frame transmission conditions, an AFC frame is transmitted when the difference between the current received Frame Sequence Number that needs to be acknowledged (currentTCxFrSeqNum) and the last acknowledged Frame Sequence Number (lastAFCxFrSeqNum) exceeds the DL_TCxOutAckThreshold threshold.

In an example of the AFC frame transmission conditions, after reception of a retransmitted data frame, when the Frame Sequence Number of that frame equals the last acknowledged Frame Sequence Number, an AFC frame is transmitted.

In an example of the AFC frame transmission conditions, an AFC frame is transmitted when the difference between the available credits (the A credit accumulator) and the transmitted credits (the S credit register) exceeds the DL_AFCxCreditThreshold threshold.

In an example of the AFC frame transmission conditions, an AFC frame is transmitted after reception of an AFCx Frame with the CReq bit set to ‘1’. The response to this case is required be transmission of AFCx with priority promoted, even when DL_PeerTCxPresent is FALSE

In an example of the AFC frame transmission conditions, an AFC frame is transmitted after reception of PA_DL_PAUSE.ind while the AFCx_REQUEST_TIMER is running. The response to this case is required to be transmission of AFCx with priority promoted.

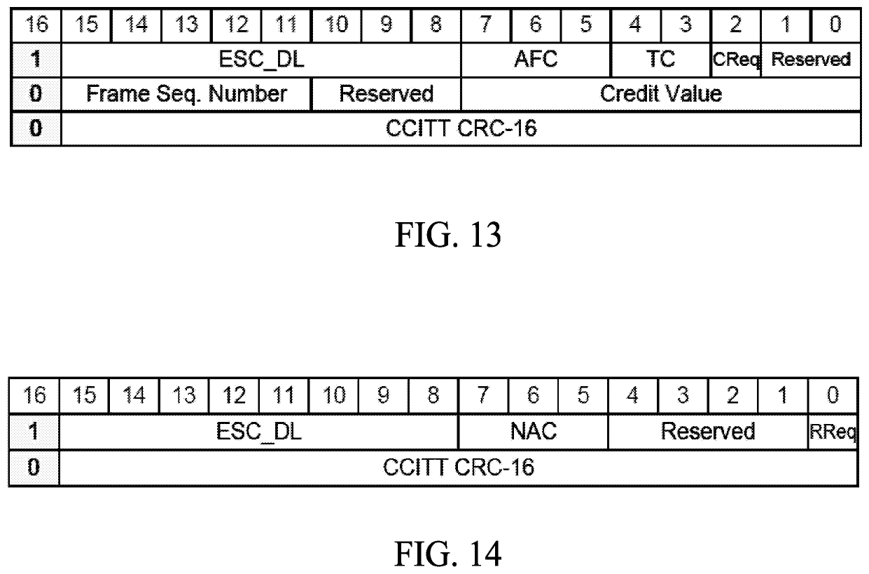

In addition, an AFC frame, illustrated in FIG. 13, includes an AFC control symbol, and two data symbols. The AFC control symbol includes a control symbol identifier ESC_DL with its parameter indicating AFC, traffic class (TC) field, CReq bit, and reserved bits. One data symbol includes a frame sequence number, reserved bits, and a credit value. The AFC frame ends with a cyclic redundancy check (CRC) field such as CCITT CRC-16, wherein CCITT stands for International Telegraph and Telephone Consultative Committee.

In addition, according to the UniPro specification (e.g., version 2.0), some NAC frame transmission conditions are taken as examples which are used to trigger the transmission of NAC frames (with a reset link request (RReq) bit set to ‘1’), wherein a NAC frame can be generated for a specific traffic class such as traffic class 0 (TC0) or traffic class 1 (TC1). The DL layer transmits a NAC frame when at least one of the conditions occurs. The NAC frame transmission will inevitably affect the performance of the entire communication system such as one shown in FIG. 1. Whenever possible, NAC Frame Transmission needs to be performed as early as possible to request the peer side to transmit data again.

In an example of the NAC frame transmission conditions, a NAC frame is transmitted when a CRC error in an incoming frame occurs.

In an example of the NAC frame transmission conditions, a NAC frame is transmitted when a RX buffer overflow of any traffic class occurs.

In an example of the NAC frame transmission conditions, a NAC frame is transmitted when a frame with a payload length more than DL_SYMBOL_MTU symbols in any traffic class is received.

In an example of the NAC frame transmission conditions, a NAC frame is transmitted when a Frame Sequence Number in a received Data Frame for any traffic class is incorrect.

In an example of the NAC frame transmission conditions, a NAC frame is transmitted when an AFCx symbol is not followed by two data symbols.

In an example of the NAC frame transmission conditions, a NAC frame is transmitted when a NAC symbol is not followed by one data symbol.

In an example of the NAC frame transmission conditions, a NAC frame is transmitted when an EOF_EVEN or EOF_ODD symbol is not followed by a data symbol, i.e. CRC symbol.

In an example of the NAC frame transmission conditions, a NAC frame is transmitted when a PA_ERROR.ind is received.

In an example of the NAC frame transmission conditions, a NAC frame is transmitted if a COF, EOF_EVEN or EOF_ODD symbol is received when a frame has not been started.

In an example of the NAC frame transmission conditions, a NAC frame is transmitted if a SOF symbol is received when a Data Frame of the same Traffic Class is already ongoing and the Data Frame is not currently preempted.

In an example of the NAC frame transmission conditions, a NAC frame is transmitted if a SOF symbol with TC=0 is received when a TC1 Data Frame is already ongoing.

In an example of the NAC frame transmission conditions, a NAC frame is transmitted if a COF control symbol is received during a data frame of the same traffic class, when that Data Frame has not been preempted.

In an example of the NAC frame transmission conditions, a NAC frame is transmitted when a COF control symbol continuing a data frame of a different traffic class is received.

In an example of the NAC frame transmission conditions, a NAC frame is transmitted when an EOF_EVEN, EOF_ODD, or a data symbol after the CRC of a preempting frame is received.

In an example of the NAC frame transmission conditions, a NAC frame is transmitted when a DL control symbol with invalid values for defined fields (e.g., undefined Control Symbol Type or traffic class) is received.

In an example of the NAC frame transmission conditions, a NAC frame is transmitted when an unexpected framing sequence or data symbols between frames are received.

In addition, a NAC frame, illustrated in FIG. 14, includes a NAC control symbol, and a data symbol. The NAC control symbol includes a control symbol identifier ESC_DL with its parameter indicating NAC, traffic class (TC) field, reserved bits and RReq bit. The NAC frame also ends with a cyclic redundancy check (CRC) field such as CCITT CRC-16.

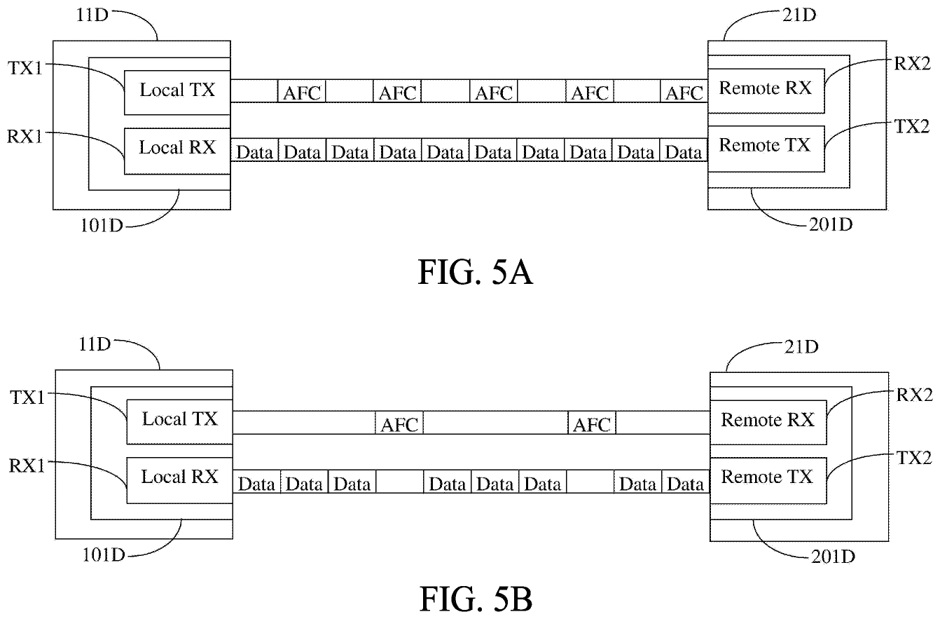

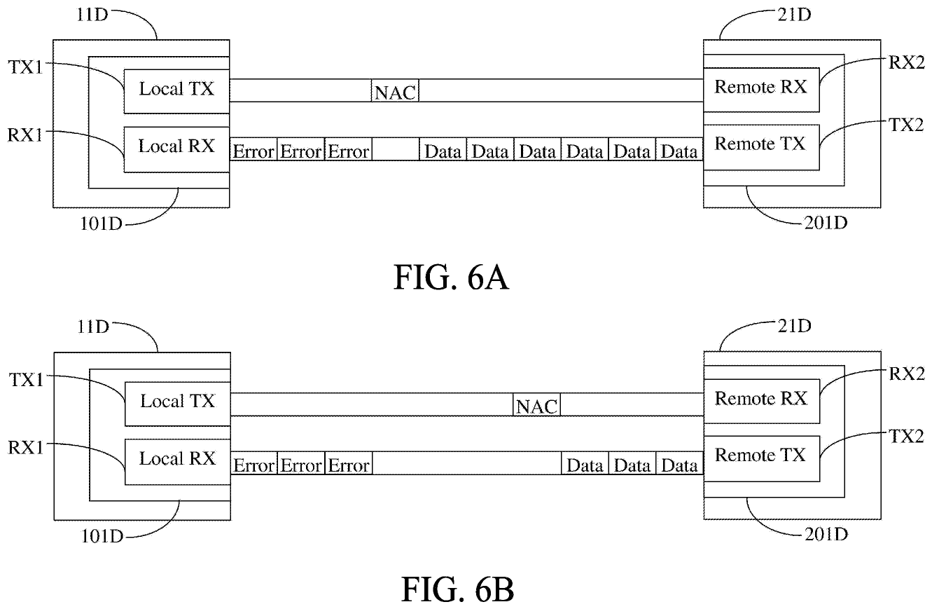

The following examples as shown in FIGS. 5A to 6B illustrate the technical effects of using the cross layer architecture based on or derived from FIG. 1 or related embodiments of FIGS. 2-4 and comparison of situations without using the cross layer architecture. Before discussion on FIGS. 5A to 6B, some assumptions are described. In a communication system, a first device (e.g., a host device) using an interconnection controller 11D and a second device (e.g., a remote device) using an interconnection controller 21D communicates according to the interconnection protocol through a lane from the first device to the second device and another lane from the second device to the first device. FIGS. 5A to 6B, like “snapshots”, show the signal transmission situations of frames between the first device and second device at a specific point of time, with rectangles having legends (e.g., “AFC”, “NAC”, or “Data”) inside to represent frames being transmitting, with blank rectangles to represent time gaps without transmitting real data, or with rectangles having legends of “Error” to represent erroneous symbols of frames. In particular, the interconnection controllers 11D and 21D implement bypass paths for control frame transmission based on one of FIGS. 1 to 4 or related examples. The interconnection controllers 11D and 21D can be configured to enable or disable the functionality of the bypass paths. FIGS. 5A to 6B show the interconnection controllers with its physical layer circuit, for the sake of illustration and brevity. One can refer to embodiments or examples related to one of FIGS. 1-4 for other implementation details. Referring to FIGS. 5A to 6B, a physical layer circuit 101D of the interconnection controller 11D having a local transmitter (TX), denoted by TX1, and a local receiver (RX), denoted by RX1. Likewise, a physical layer circuit 201D of the interconnection controller 21D having a remote transmitter (TX), denoted by TX2, and a remote receiver (RX), denoted by RX2.

For data frame transmission, for example, when transmitting a DL layer data frame to the peer side, the interconnector controller (e.g., 11D or 21D) stores the data of the DL layer data frame in a buffer temporarily in case that re-transmission (or called replay) of the DL layer data frame is needed. For example, the re-transmission is needed if a timer associated with the DL layer data frame expires or a NAC frame is received. Before the timer expires or a NAC frame is received, if an AFC frame associated with the DL layer data frame is received, the data of the DL layer data frame can be released from the buffer; otherwise, the data of the DL layer data frame retains in the buffer. The similar operations are performed for another DL layer data frame to be transmitted. If the buffer is full, the transmission of DL frames will be paused until an AFC or NAC frame is received or expiration of a timer, for example.

FIG. 5A illustrates an example of frame transmission with using bypass paths for AFC frame transmission. In FIG. 5A, the interconnection controllers 11D and 21D are configured to enable the functionality of the bypass paths. In the scenario of this example, the interconnection controller 21D transmits data (such as data symbols of DL layer data frames) through the remote TX (TX2) to the local RX (RX1) of the interconnection controller 11D and the local RX (RX1) of the interconnection controller 11D receives the data correctly. Thus, the DL layer of the interconnection controller 11D transmits AFC frames associated with the DL layer data frames through the local TX (TX1) to the remote RX (RX2) of the interconnection controllers 21D. Accordingly, as illustrated in FIG. 5A, the interconnection controller 21D of the remoted device can transmit the DL layer data frames consecutively without substantial time gaps among them through the remote TX (TX2) because of AFC frame transmission of the host device with shorter latency under the cross layer architecture. In FIG. 5A, the interconnection controller 21D, after receiving an AFC frame through the remote RX (RX2), can be informed that a DL layer data frame associated with the AFC frame has been received by its peer side (e.g., the host device) shortly after the interconnection controller 21D transmits the DL layer data frame through the remote TX (TX2). Specifically, in the DL layer of the interconnection controller 21D, the buffer for storing data for re-transmission can be prevented from being full because of the informing of the reception of the AFC frame. In this manner, the interconnection controller 21D can transmit a series of data without gaps of time through the remote TX (TX2).

FIG. 5B illustrates an example of frame transmission without using bypass paths for AFC frame transmission. The interconnection controllers 11D and 21D are configured to disable the functionality of the bypass paths. In the scenario of this example, the interconnection controller 21D also transmits data (such as data symbols of DL layer data frames) through the remote TX (TX2) to the local RX (RX1) of the interconnection controller 11D and the local RX (RX1) of the interconnection controller 11D receives the data correctly. In contrast to the situation shown in FIG. 5A, AFC frames are transmitted to the remote device with a longer latency in FIG. 5B because the functionality of the bypass paths is disabled or cross layer architecture is not used. As compared to the scenario of FIG. 5A, the interconnection controller 21D in FIG. 5B obtains the AFC frames later so the interconnection controller 21D transmits the data with gaps of time.

FIG. 6A illustrates an example of frame transmission with bypass paths with respect to NAC frames. The interconnection controllers 11D and 21D are configured to enable the functionality of the bypass paths. In the scenario of this example, the interconnection controller 21D transmits data (such as data symbols of DL layer data frames) through the remote TX (TX2) to the local RX (RX1) of the interconnection controller 11D but the local RX (RX1) of the interconnection controller 11D receives some erroneous data. Thus, the DL layer of the interconnection controller 11D transmits NAC frames associated with the erroneous data through the local TX (TX1) to the remote RX (RX2) of the interconnection controllers 21D. Accordingly, as illustrated in FIG. 6A, the interconnection controller 21D of the remoted device can re-transmit the DL layer data frames with a little amount of time gap through the remote TX (TX2) because of NAC frame transmission of the host device with shorter latency under the cross layer architecture. In FIG. 5A, the interconnection controller 21D, after receiving a NAC frame through the remote RX (RX2), can be informed that a DL layer data frame associated with the AFC frame has not been received by its peer side (e.g., the host device) shortly after the interconnection controller 21D transmits the DL layer data frame through the remote TX (TX2). In this manner, the interconnection controller 21D can re-transmit a series of data quickly through the remote TX (TX2) with a little amount of time gap.

FIG. 6B illustrates an example of frame transmission without bypass paths with respect to NAC frames. The interconnection controllers 11D and 21D are configured to disable the functionality of the bypass paths. In the scenario of this example, the interconnection controller 21D also transmits data (such as data symbols of DL layer data frames) through the remote TX (TX2) to the local RX (RX1) of the interconnection controller 11D but the local RX (RX1) of the interconnection controller 11D receives some erroneous data. In contrast to the situation shown in FIG. 6A, a NAC frame is transmitted to the remote device with a longer latency in FIG. 6B because the functionality of the bypass paths is disabled or cross layer architecture is not used. As compared to the scenario of FIG. 6A, the interconnection controller 21D in FIG. 6B obtains the NAC frame later so the interconnection controller 21D re-transmits the data with a greater amount of time gap.

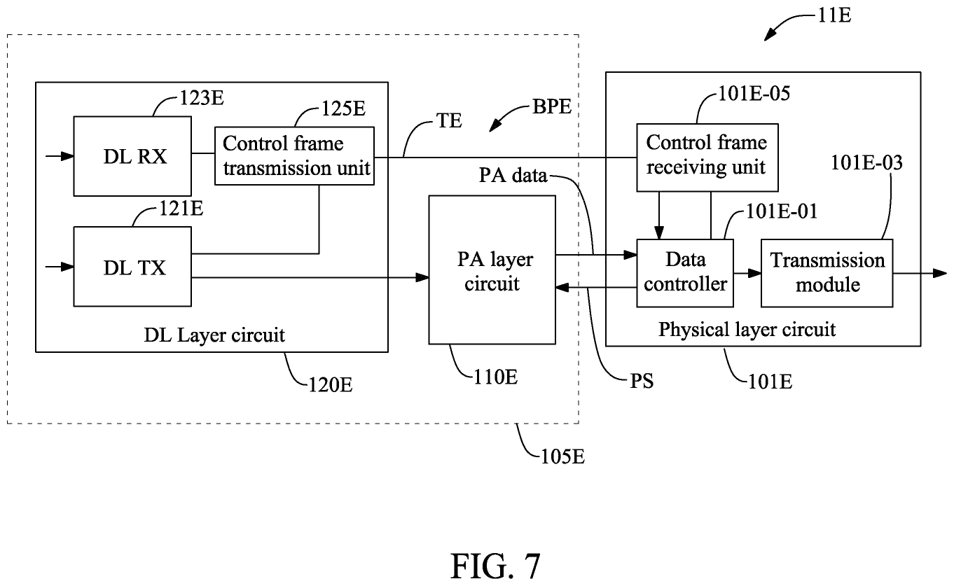

FIG. 7 is a block diagram illustrating an embodiment of a device based on FIG. 2 with respect to a bypass path connected between a link controller and a physical layer circuit. In FIG. 7, an interconnection controller 11E is shown with a bypass path BPE, providing an architecture for hardware implementation of an interconnection controller, which can be regarded as an embodiment of the interconnection controller 11 in FIG. 1 or can be applied to the implementation of the interconnection controller 21 in FIG. 1. The interconnection controller 11E includes a link controller 105E for implementing the protocol layer (or “link layer”) and a physical layer circuit 101E for signal transmission. The link controller 105E includes, for example, a physical adapter (PA) layer circuit 110E and a data link (DL) layer circuit 120E, and so on. In particular, the bypass path BPE is connected between a circuit stage of the link controller 105E and the physical layer circuit 101E. For example, the bypass path BPE includes a circuit module (such as a control frame transmission unit 125E) in the DL layer circuit 120E, a bus TE including one or more lines or traces, and a circuit module (such as a control frame receiving unit 101E-05) in the physical layer circuit 101E.

The control frame transmission unit 125E in the DL layer circuit 120E is used for transmitting a control frame directly to the control frame receiving unit 101E-05 in physical layer circuit 101E through the bus TE.

In this regard, as shown in FIG. 7, the DL layer circuit 120E includes a DL transmitter (TX) 121E, a DL receiver (RX) 123E, and the control frame transmission unit 125E coupled to the DL TX 121E and DL RX 123E. The DL TX 121E transmits DL layer data frames to the PA layer circuit 110E. For example, a control frame such as AFC or NAC frame can be generated by the DL TX 121E or the control frame transmission unit 125E. The DL TX 121E and DL RX 123E may generate a control frame request, for example, according to the AFC frame transmission conditions or NAC frame transmission conditions as exemplified above. In response to the control frame request, the DL layer circuit 120E can generate a control frame. The control frame transmission unit 125E can transmit the control frame directly to the control frame receiving unit 101E-05 in physical layer circuit 101E through the bus TE to bypass the PA layer circuit 110E. In addition, the control frame transmission unit 125E can transmit the control frame with a COF control symbol when the link controller 105E implements the UniPro specification. Alternatively, the COF control symbol can be generated in the control frame receiving unit 101E-05.

In addition, the control frame transmission unit 125E can transmit a control signal associated with the control frame to the control frame receiving unit 101E-05. In response to the control signal and the control frame, the control frame receiving unit 101E-05 transmits a signal to request the physical layer circuit 101E to transmit a control information signal based on the control frame and pause the signal transmission which is based on PA data received from the PA layer circuit 110E.

In this regard, as shown in FIG. 7, the physical layer circuit 101E includes a data controller 101E-01, a transmission module 101E-03, and the control frame receiving unit 101E-05 coupled to the data controller 101E-01. In response to the control signal and the control frame, the control frame receiving unit 101E-05 transmits a signal (or called preemption request) to the data controller 101E-01 to request the physical layer circuit 101E to transmit a control information signal based on the control frame and pause the signal transmission based on the received PA data. Upon receiving the preemption request, the data controller 101E-01 transmits a pause signal, denoted by PS, (e.g., a signal being asserted) to the PA layer circuit 110E to request the PA layer circuit 110E to pause its data transmission to the physical layer circuit 101E. Meanwhile, the data controller 101E-01 receives the control frame and COF control symbol output from the control frame receiving unit 101E-05 and transmits them to the subsequent stages such as the transmission module 101E-03 to transmit a control information signal based on the control frame and COF control symbol. After that, the data controller 101E-01 triggers the PA layer circuit 110E to proceed with the data transmission by de-asserting the pause signal.

Accordingly, based on the architecture of FIG. 2, the control frame can be transmitted directly from the DL layer circuit 120E to the physical layer circuit 101E to bypass the PA layer circuit 110E. In this manner, latency of transmitting the control frame from the DL layer circuit 120E to the physical layer circuit 101E can thus be reduced more effectively and more efficiently. By contrast, if the control frame such as AFC or NAC frame is transmitted to the physical layer circuit 101E via the PA layer circuit 110E in a pipelined-based architecture, the control frame needs to wait in line when the control frame is generated later than the other data link layer data symbols or PA layer control symbols, thereby leading to a longer latency. Specifically, lane distribution, skip symbol insertion, and idle skip symbol insertion that are performed in the PA layer circuit 110E may contribute to the longer latency in a case that the link controller 105E is implemented based on the UniPro specification (e.g., version 2.0).

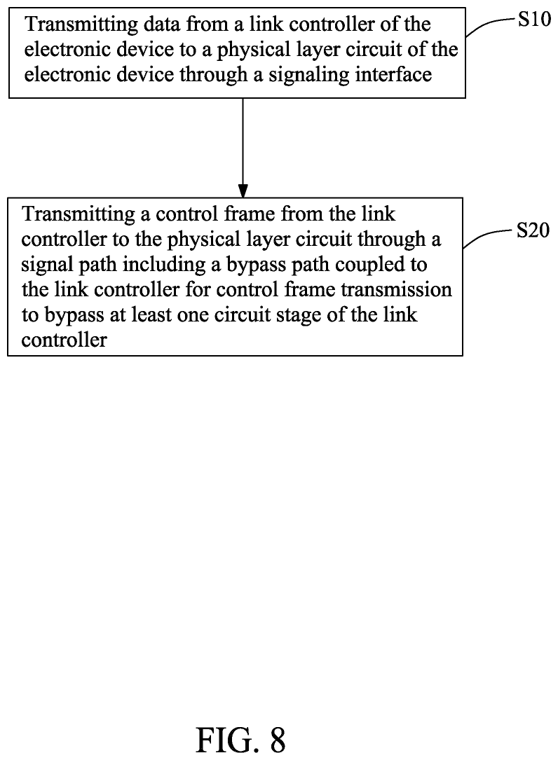

FIG. 8 is a flowchart illustrating an embodiment of a method for facilitating control frame transmission. In FIG. 8, the method includes steps S10 and S20.

In step S10, transmitting data from a link controller of the electronic device to a physical layer circuit of the electronic device through a signaling interface (e.g., SF1 or SF2). For example, the link controller and the physical layer circuit are based on any one of embodiments or examples of FIGS. 1-7 or others.

In step S20, transmitting a control frame (e.g., AFC or NAC frame) from the link controller to a physical layer circuit through a signal path including a bypass path coupled to the link controller for control frame transmission to bypass at least one circuit stage of the link controller.

In an embodiment based on FIG. 8, the control frame is transmitted from the link controller to a physical layer circuit directly through the signal path including the bypass path. For example, the bypass path such as BP1, BP2, BPA, BPC, BPE, is based on any one of embodiments or examples of FIGS. 1, 2, 4-7 or others.

In some examples, the control frame (e.g., AFC or NAC frame) can be transmitted from the link controller to a physical layer circuit through the signal path including a bypass path (e.g., BPB) and a signaling interface (e.g., SF1), as illustrated based on FIG. 3.

In an embodiment based on FIG. 8, the method further comprises: in response to the control frame, transmitting, by the physical layer circuit, a control information signal based on the control frame and pausing signal transmission which is based on the data received through the signaling interface.

In an embodiment based on FIG. 8, the method further comprises: proceeding with the signal transmission which is based on the data received through the signaling interface after transmitting the control information signal based on the control frame.

Generally, the cross layer architecture can be realized with different preemption locations. The preemption location is a location of the circuit of an interconnection controller where a bypass path for control frame transmission from the DL layer ends. As described above, the preemption location can be configured in the end of the PA layer (e.g., before a signaling interface such as RMMI interface) or inside the physical layer (e.g., after the RMMI interface). The following embodiments adopt a configuration having the preemption location inside the physical layer. In implementation of control of the preemption, will base on RMMI interface and add more signal to fulfill this feature.

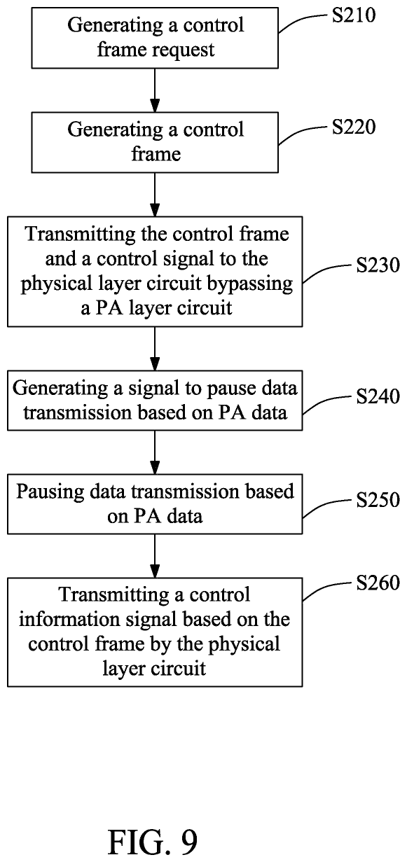

FIG. 9 illustrates an embodiment of a method for facilitating control frame transmission. As shown in FIG. 9, the method includes steps S210-S260. In the following, FIG. 7 is referred for the sake of illustration and the implementation of the method is not restricted to the examples.

In step S210, a control frame request is generated. For example, referring to FIG. 7, the DL TX 121E or DL RX 123E may issue the control frame request according to the AFC or NAC frame transmission conditions above to the control frame transmission unit 125E or DL TX 121E.

In step S220, a control frame is generated. In response to the control frame request, the DL layer circuit 120E can generate the control frame. In an example referring to FIG. 7, the control frame transmission unit 125E generates the control frame. In another example, the DL TX 121E generates a control frame in response to the control frame request and outputs the control frame to the control frame transmission unit 125E.

In step S230, the control frame and a control signal is transmitted to the physical layer circuit bypassing a PA layer circuit. For example, the control frame transmission unit 125E transmits the control frame (e.g., AFC or NAC frame) and a control signal (e.g., a signal being asserted) associated with the control frame to the control frame receiving unit 101E-05 in the physical layer circuit 101E bypassing the PA layer circuit 110E.

In step S240, a signal is generated to pause data transmission based on PA data. As described in the above examples of FIG. 7, in response to the control signal and the control frame, the control frame receiving unit 101E-05 requests the physical layer circuit 101E to transmit a control information signal based on the control frame and pause the signal transmission based on the received PA data. The data controller 101E-01 transmits a pause signal (PS) (e.g., a signal being asserted) to the PA layer circuit 110E to request the PA layer circuit 110E to pause data transmission.

In step S250, data transmission based on PA data is paused. For example, in response to the pause signal, the PA layer circuit 110E pauses its data transmission to the physical layer circuit 101E.

In step S260, a control information signal is transmitted based on the control frame by the physical layer circuit. For example, while the PA layer circuit 110E pauses the data transmission, the data controller 101E-01 receives the control frame and COF control symbol output from the control frame receiving unit 101E-05 and transmits them to the subsequent stages such as the transmission module 101E-03 to transmit a control information signal based on the control frame and COF control symbol.

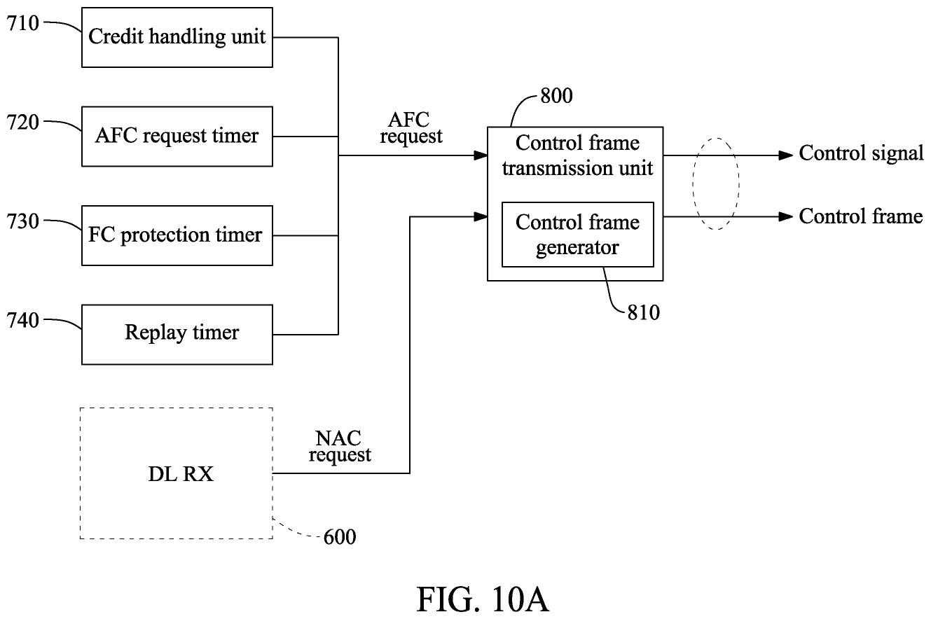

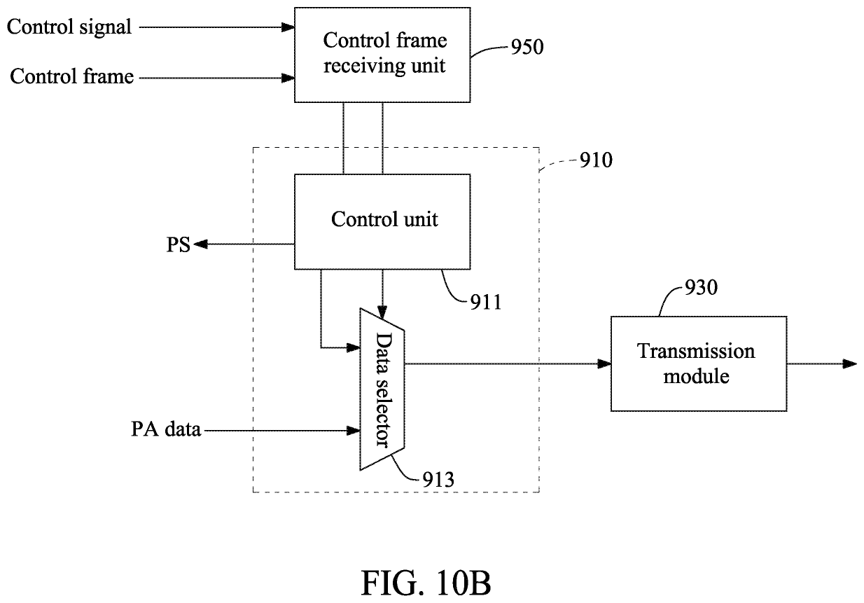

FIG. 10A illustrates an embodiment of a circuit based on FIG. 2 with respect to a bypass path. In FIG. 10A, a control frame transmission unit 800 can be taken as an embodiment of the circuit module (e.g., M1A, M1B, 125E, or related examples in FIG. 2, FIG. 3, FIG. 7, or so on) in a bypass path (e.g., TA, TB, TE, or other examples in FIG. 2, FIG. 3, FIG. 7, or so on). The control frame transmission unit 800 transmits a control frame and a control signal associated with the control frame through a bus of the bypass path, where the bus may have two or more lines or traces. In addition, operations related to FIG. 10A and described below can be regarded as embodiments of the steps (e.g., S20, S210, S220, S230, or so on) of the method based on FIG. 8, FIG. 9, or related examples, whenever appropriate.

The control frame transmission unit 800 includes a control frame generator 810 for generating a control frame such as an AFC or NAC frame, in response to an AFC request or NAC request issued by some circuit modules in the DL layer circuit (e.g., 120A, 120B, 120E, or other examples in FIG. 2, FIG. 3, FIG. 7, or so on). For example, a credit handling unit 710 for handling credits in the data link layer may issue an AFC request to generate an AFC frame, based on at least one of the AFC frame transmission conditions about credits (mentioned previously). For example, an AFC request timer 720 may issue an AFC request to generate an AFC frame, based on at least one of the AFC frame transmission conditions about an AFC request timer (mentioned previously). For example, a flow control (FC) protection timer 730 may issue an AFC request to generate an AFC frame, based on at least one of the AFC frame transmission conditions about a flow control (FC) protection timer (mentioned previously). For example, a replay timer 740 may issue an AFC request to generate an AFC frame, based on at least one of the AFC frame transmission conditions about a replay timer (mentioned previously). For example, a DL receiver (RX) 600 that handles one or more tasks in data link layer may issue a NAC request to generate a NAC frame, based on at least one of the NAC frame transmission conditions (mentioned previously).

FIG. 10B illustrates an embodiment of a circuit based on FIG. 2 with respect to a bypass path connected between a link controller and a physical layer circuit. In FIG. 10B, a control frame receiving unit 950 (or referred to as a preemption controller) can be taken as an embodiment of the circuit module (e.g., M2A, 101E-05, or related examples in FIG. 2, FIG. 7, or so on) in a bypass path (e.g., TA, TE, or other examples in FIG. 2, FIG. 7, or so on). The control frame receiving unit 950 receives a control frame and a control signal associated with the control frame through a bus of the bypass path, where the bus may have two or more lines or traces. In addition, a data controller 910 includes a control unit 911 and a data selector 913, which can be regarded as an embodiment of the data controller 101E-01 of FIG. 7, or can be implemented in a physical layer circuit (e.g., 101A, 101C, 101E, or related examples). Further, operations related to FIG. 10B and described below can be regarded as embodiments of the steps (e.g., S20, S240, S250, S260, or so on) of the method based on FIG. 8, FIG. 9, or related examples, whenever appropriate.

In response to the control signal and the control frame (or further with the COF control symbol), the control frame receiving unit 950 transmits a signal (or called a preemption request) to the control unit 911 of the data controller 910 to request a physical layer circuit (e.g., 101A, 101C, or 101E as shown in FIG. 1, FIG. 2, or FIG. 7, or related examples) to transmit a control information signal (e.g., a signal output by the physical layer circuit according to an M-PHY specification (such as version 5.0)) based on the control frame and pause the signal transmission based on PA data received from a PA layer circuit (e.g., 110A, 110C, or 110E as shown in FIG. 1, FIG. 2, or FIG. 7, or related examples). Upon receiving the preemption request, the control unit 911 of the data controller 910 transmits a pause signal PS (e.g., a signal being asserted) to the PA layer circuit to request the PA layer circuit to pause its data transmission to the physical layer circuit. Meanwhile, the control frame receiving unit 950 outputs the control frame and COF control symbol as preemption input data to the data selector 913 through the control unit 911 of the data controller 910. In response to the preemption request, the control unit 911 of the data controller 910 transmits a selection signal to control the data selector 913 to select the preemption input data as output data of the data selector 913. The data selector 913 outputs the output data to the subsequent stages of the physical layer circuit such as a transmission module 930 (e.g., a transmitter) to transmit a control information signal based on the control frame and COF control symbol. After that, the control unit 911 of the data controller 910 triggers the PA layer circuit (e.g., 110E) to proceed with the data transmission by de-asserting the pause signal PS, for example. The control unit 911 can then transmit a signal (or called a preemption completion signal) to the control frame receiving unit 950 to inform the control frame receiving unit 950 of the completion of the preemption request.

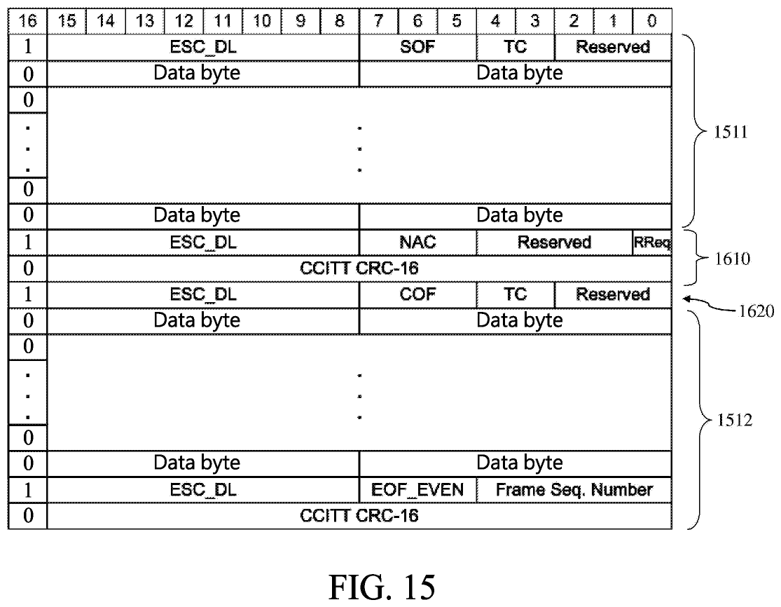

Regarding the preemption of the control frame above, FIG. illustrates an embodiment of a data frame preempted by a control frame through a bypass path. Taking the scenario and operations related to FIG. 10B as an example, while a PA layer circuit is outputting PA data including data of a DL layer data frame indicated by data 1511, the PA layer circuit receives a pause signal (PS) from the data controller 910 and pauses its data transmission of the PA data, wherein the data 1511 includes a control symbol identifier ESC_DL with its parameter indicating start-of-frame (SOF), a traffic class field, and reserved bits, and includes a number of data bytes. Meanwhile, the control frame receiving unit 950 outputs the control frame and COF control symbol as preemption input data to the data selector 913. The control frame, for example, is based on a NAC frame, as indicated by data 1610 in FIG. 15 and the COF control symbol, as indicated by data 1620 in FIG. 15, includes a control symbol identifier ESC_DL with its parameter indicating COF, a traffic class field, and reserved bits. In response to the selection signal, the data selector 913 outputs the preemption input data as output data to the subsequent stages of the physical layer circuit (e.g., transmission module 930) so as to transmit a control information signal. After that, the data controller 910 triggers the PA layer circuit to proceed with the data transmission by de-asserting the pause signal PS, for example. Afterwards, the PA layer circuit proceeds to output the remaining portion of the preempted DL layer data frame, as indicated by data 1512 in FIG. 15, wherein the data 1512 includes the remaining data bytes, a control symbol identifier ESC_DL with its parameter indicating EOF_EVEN, a frame sequence number, and a data bytes of CCITT CRC-16.

In an embodiment, the control frame receiving unit 950 can be implemented by logic circuits and so on, for example, including a buffer such as latches or so on to store temporarily the control frame and COF control symbol, and a control logic to handle the control signal and interact with the data controller 910, as described in the above operations related to FIG. 10B. In an embodiment, the control frame receiving unit 950 can be implemented to output the control frame and COF control symbol to the data selector 913 directly via traces.

In some embodiments, the circuit of FIG. 10B can be modified to meet the need for the cross layer architecture with different preemption locations. For example, the circuit of FIG. 10B can be disposed and included in a PA layer circuit (e.g., 110B in FIG. 3) based on the embodiment of FIG. 3. For example, the data controller 910 can receive PA data from the PA layer processing unit 113B of FIG. 3 and output a pause signal (PS) to the PA layer processing unit 113B, wherein the output data of the data selector 913 is output to the interfacing module 111B of FIG. 3 so as to realize the preemption location in the PA layer circuit 110B.

Further, when a communication system based on FIG. 7 or so on implements the interconnection protocol derived from the UniPro specification, in relation to the COF control symbol (e.g., data 1620 in FIG. 15) that follows the control frame (e.g., data 1610 in FIG. 15), it needs to set the traffic class field of the COF control symbol to the same traffic class in the data 1511 of a DL layer data frame.

In some embodiments, if a communication system based on FIG. 7 or so on supports only one type of traffic class, such as traffic class 0 (TC0), the traffic class field has a fixed value and the traffic class field of the COF control symbol can be set accordingly.

In some embodiments, if a communication system based on FIG. 7 or so on supports at least two types of traffic class, such as traffic class 0 (TC0) or traffic class 1 (TC1), the traffic class field of the COF control symbol can be set to a value that matches the same traffic class of a DL layer data frame that an associated control frame preempts, by using a traffic class (TC) recording unit. For example, the traffic class (TC) recording unit is a logic unit or circuit for recording traffic class and configured in the DL layer circuit 120E, including elements such as flags (or registers) and logic circuits. Whenever the DL layer circuit 120E transmits a DL layer data frame, the TC recording unit records the traffic class of the transmitted data frame. Afterwards, the DL layer circuit 120E as shown in FIG. 7 can generate a control frame accompanied with a traffic class value obtained from the TC recording unit in response to a control frame request generated by the DL TX 121E or DL RX 123E. With the traffic class value obtained from the TC recording unit, the COF control symbol used in the preemption in the physical layer circuit 101E can be generated by the DL layer circuit 120E (e.g., control frame transmission unit 125E) or physical layer circuit 101E (e.g., control frame receiving unit 101E-05).

In addition, since the latency of the PA layer circuit 110E, for example, implemented in pipelined circuits, is a fixed number of clock cycles (e.g., 2, 3 clock cycles, or so on), the DL layer circuit 120E can be configured to provide a traffic class value that matches the DL layer data frame that is preempted in the physical layer circuit 101E. TABLE 1 illustrates, in an embodiment of the TC recording unit, records of traffic class values for DL layer data frames that are output to the PA layer circuit 110E sequentially with time. In TABLE 1, the smaller the number in the row of time is, the earlier the time when a DL layer data frame is transmitted to the PA layer circuit 110E is, for sake of illustration.

TABLE 1

| Time | 1 | 2 | 3 | 4 | 5 | 6 |
|---|---|---|---|---|---|---|
| Traffic | TC1 | TC1 | TC1 | TC0 | TC0 | TC0 |
| class | | | | | | |

In an example, it is assumed that the latency of the PA layer circuit 110E is two clock cycles and it is going to perform the preemption of a control frame (or insertion of the COF control symbol) by using a bypass path at the time of 4. The DL layer circuit 120E can trace back to the traffic class value at the time of 2 (4−2=2) by using the records maintained by the TC recording unit, as illustrated in TABLE 1, and expect that the physical layer circuit 101E is processing a DL layer data frame for TC1 at the time of 2. Accordingly, the DL layer circuit 120E can determine the traffic class value for the COF control symbol for preemption in the physical layer circuit 101E to indicate TC1.

Further, the COF control symbol may not need to be generated when tracing back to the records maintained by the TC recording unit and finding that no DL layer data frame is processed in the DL layer circuit 120E. TABLE 2 illustrates, in another embodiment of the TC recording unit, records of traffic class values for DL layer data frames that are output to the PA layer circuit 110E sequentially with time, wherein “X” indicates no transmission of DL layer data frame.

TABLE 2

| Time | 1 | 2 | 3 | 4 | 5 | 6 | 7 | 8 | 9 | 10 |
|---|---|---|---|---|---|---|---|---|---|---|
| Traffic | TC1 | TC1 | TC1 | TC0 | TC0 | TC0 | X | X | X | X |
| class | | | | | | | | | | |

In an example, it is assumed that the latency of the PA layer circuit 110E is two clock cycles and it is going to perform the preemption of a control frame (or insertion of the COF control symbol) by using a bypass path at the time of 9. The DL layer circuit 120E can trace back to the traffic class value at the time of 7 (9−2=7) by using the records maintained by the TC recording unit, as illustrated in TABLE 2, and expects that the physical layer circuit 101E is not processing a DL layer data frame at the time of 7. Meanwhile, if the PA layer circuit 110E does not output a PACP frame to the physical layer circuit 101E, the DL layer circuit 120E can transmit a control frame to the physical layer circuit 101E by using the bypass path BPE without the COF control symbol. If the PA layer circuit 110E is outputting a PACP frame to the physical layer circuit 101E, the DL layer circuit 120E can transmit a control frame to the physical layer circuit 101E by using the bypass path BPE without the COF control symbol so long as the PA layer circuit 110E finishes the PACP frame transmission. For example, according to the UniPro specification (e.g., version 2.0), when the PA Layer needs to execute an operation that requires the usage of the link (e.g., power mode change or PACP frame transmission), a handshake procedure is used between the PA layer and DL layer to coordinate the link usage (e.g., using control primitives denoted by “PA_DL_PAUSE”). By using the handshake procedure, the DL layer circuit 120E can be informed of whether the PA layer circuit 110E is transmitting a PACP frame or so on. Accordingly, the DL layer circuit 120E can be implemented to determine as to whether to transmit a control frame to the physical layer circuit 101E by using the bypass path BPE with or without the COF control symbol accordingly.

Various embodiments are provided below for facilitating an interconnection protocol, and are suitable for an electronic device capable of communicating with another electronic device according to the interconnection protocol. The interconnection protocol can be derived from the UFS standard or UniPro specification. For example, a conventional UFS system includes a UFS host and a UFS device. The UFS host and the UFS device communicate each other through respective UFS Interconnect (UIC) layer including UniPro and M-PHY. Accordingly, the interconnection protocol can be implemented and derived from architecture of the conventional UFS system by using a modified UFS system implementing a modified version of UniPro and a modified version of M-PHY.

In the following embodiments, the UniPro specification such as UniPro version 2.0 is taken as examples. Certainly, the implementation of the disclosure is not limited thereto.

The following provides various embodiments for implementation of the interconnection protocol.

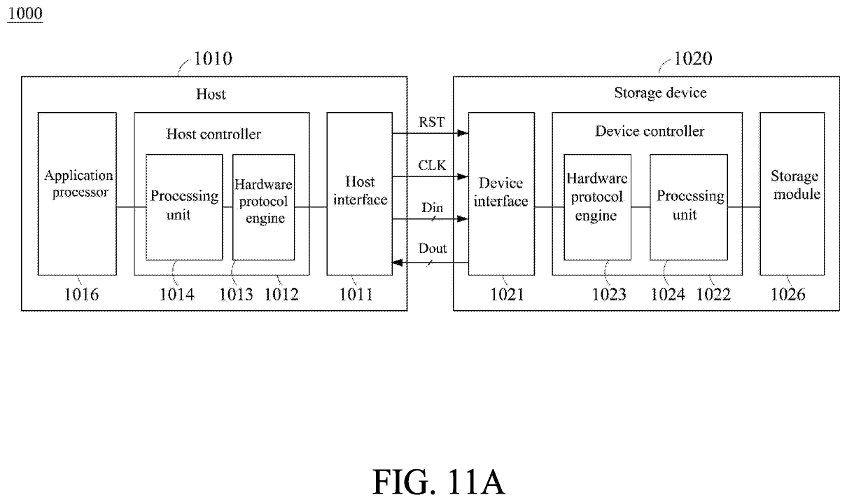

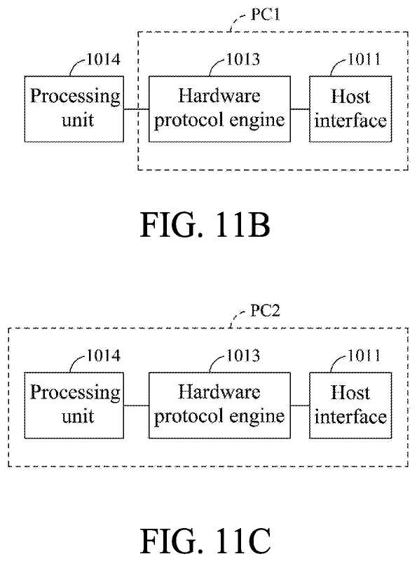

Referring to FIG. 11A, a diagram of circuit architecture is shown according to an embodiment of the present disclosure. As shown in FIG. 11A, a storage system 1000 includes a host 1010 and a storage device 1020. The host 1010 and the storage device 1020 communicate through an interconnection protocol, thereby allowing the host 1010 to perform data access of the storage device 1020. In addition, one or more of the embodiments of FIGS. 1-4, 7, 10A-10B or related examples regarding cross layer architecture, whenever appropriate, can be applied to the circuit architecture of FIG. 11A or its related examples such as FIG. 11B or FIG. 11C. According to the circuit architecture in FIG. 11A, the foregoing technique about the cross layer architecture is applicable to a first device 10 of one or more of the embodiments above capable of communicating with a second device 20 of one or more of the embodiments above according to the interconnection protocol, wherein the host 1010 and storage device 1020 can be used to implement the first device 10 and second device 20 respectively, or vice versa. In the circuit architecture of FIG. 11A, a controller in the host 1010 or the storage device 1020 used to implement the interconnection protocol may be implemented by various configurations. As shown in FIG. 11A, the controller (for example, a host controller 1012) in the host 1010 used to implement the interconnection protocol or the controller (for example, a device controller 1022) in the storage device 1020 used to implement the interconnection protocol can be implemented as circuit architecture including a hardware protocol engine and a processing unit, wherein the processing unit of the controller is optional. In another example, as shown in FIG. 11B, the controller in the host 1010 used to implement the interconnection protocol is referred to as, for example, a protocol controller PC1, which can be configured to include a host interface 1011 and a hardware protocol engine 1013 and be implemented as a single chip, wherein a processing unit 1014 may be regarded as an external circuit of the protocol controller PC1. Moreover, similarly, the controller (or referred to as a protocol controller of the storage device 1020) in the storage device 1020 used to implement the interconnection protocol can be configured to include a device interface 1021 and a hardware protocol engine 1023 and be implemented as a single chip, wherein a processing unit 1024 may be regarded as an external circuit of the protocol controller. For another example, as shown in FIG. 11C, the controller in the host 1010 used to implement the interconnection protocol, for example, a protocol controller PC2, can be configured to include the host interface 1011, the hardware protocol engine 1013 and the processing unit 1014, and be implemented as a single chip. Moreover, similarly, the controller (or referred to as a protocol controller of the storage device 1020) in the storage device 1020 used to implement the interconnection protocol can be configured to include the device interface 1021, the hardware protocol engine 1023, and the processing unit 1024, and be implemented as a single chip. Thus, according to the circuit architecture in FIG. 11A, the controller used to implement the interconnection protocol in the host 1010 or the storage device 1020 can be regarded to cover or represent the embodiment based on FIG. 11A, FIG. 11B, or FIG. 11C. The description of other examples related to FIG. 11A is also suitable for the embodiments based on FIG. 11A, FIG. 11B, or FIG. 11C.

The circuit architecture shown in FIG. 11A has sufficient flexibilities and can be efficiently configured to meet requirements of different products, so as to adapt to diversified designs of manufacturers for better product development. The host 1010 is, for example, a computing device such as a smartphone, a tablet computer, a multimedia device, or other electronic devices. The storage device 1020 is, for example, a storage device inside or outside the computing device, and is such as a storage device based on a non-volatile memory. The storage device 1020 is capable of being written with data under control of the host 1010 or providing written data to the host 1010. The storage device 1020 can be implemented as an internal memory device, memory card, solid state drive (SSD), or so on; however, the implementation of the present disclosure is not limited to the examples above.

The host 1010 includes the host interface 1011, the host controller 1012, and an application processor 1016.

The host interface 1011 implements a physical layer of the interconnection protocol so as to link to the storage device 1020. For example, the host interface 1011 implements a modified version of physical (M-PHY) layer, based on one or more of the embodiments of FIGS. 1-10B or related examples, whenever appropriate.

The host controller 1012 is coupled between the host interface 1011 and the application processor 1016. When the application processor 1016 needs to perform data access of the storage device 1020, it transmits a corresponding access operation command or write data to the host controller 1012 and communicates with the storage device 1020 through the interconnection protocol, thereby completing data access of the storage device 1020.

The host controller 1012 includes, for example, the hardware protocol engine 1013 and the processing unit 1014, wherein the processing unit 1014 is optional.

The hardware protocol engine 1013 implements a link layer of the interconnection protocol. The link layer can be implemented according to a modified version of UniPro as exemplified above. The hardware protocol engine 1013 communicates with the host interface 1011 and the processing unit 1014 and performs data conversion according to the specification of the link layer. In addition, the hardware protocol engine 1013 (or the host controller 1012) can be regarded as an embodiment of the link controller 105 of the first device 10 shown in FIG. 1, or can be based on one or more of the embodiments of FIGS. 1-10B or related examples, whenever appropriate.

The processing unit 1014 is coupled to the hardware protocol engine 1013, and communicates with the application processor 1016. The processing unit 1014 can execute one or more pieces of firmware. For example, an access operation command or write data output by an operating system, a driver, or an application executed by the application processor 1016 is converted into a command or data in a format compliant with the link layer of the interconnection protocol by the firmware executed by the processing unit 1014, and is then output to the hardware protocol engine 1013 for processing according to specification of the link layer. Alternatively, read data returned by the storage device 1020 in response to a read command of the host 1010 is returned to the hardware protocol engine 1013 according to the specification of the link layer of the interconnection protocol, and is converted by the corresponding firmware executed by the processing unit 1014 into data in a format that is compliant with and readable by the operating system, driver, or application executed by the application processor 1016. The firmware can be stored, for example, in an internal memory of the processing unit 1014, or be stored in an internal memory of the host controller 1012, wherein the internal memory can include a volatile memory and a non-volatile memory. The processing unit 1014 is optional, that is, the task of the firmware above may be implemented in the hardware protocol engine 1013 in hardware.

The storage device 1020 includes the device interface 1021, the device controller 1022, and a storage module 1026.

The device interface 1021 implements a physical layer of the interconnection protocol to link to the host 1010. For example, the device interface 1021 is for implementing a modified version of physical (M-PHY) layer, based on one or more of the embodiments of FIGS. 1-10B or related examples, whenever appropriate.

The device controller 1022 is coupled between the device interface 1021 and the storage module 1026. The device controller 1022 has functions corresponding to or similar to those of the host controller 1012 described above, with respect to the interconnection protocol. When the host 1010 issues and transmits an access operation command or write data to the storage device 1020 through the interconnection protocol, the device controller 1022 converts the received data into a corresponding access operation command or write data through the interconnection protocol so as to facilitate data access to be performed by the storage module 1026. Alternatively, the device controller 1022 returns, according to the link layer of the interconnection protocol, read data returned by the storage device 1020 in response to the read command of the host 1010 to the host 1010. The storage module 1026 includes, for example, a memory chip of one or more non-volatile memories, and is, for example, a flash memory chip. In one example, the storage device 1020 may further include a flash memory controller. The flash memory controller is coupled between the device controller 1022 and the storage module 1026, and can be configured to control write, read, or erase operations of the storage module 1026, and is capable of performing data exchange with the storage module 1026 through an address bus or a data bus. In another example, the flash memory controller may be further provided in the device controller 1022.

The device controller 1022 includes, for example, the hardware protocol engine 1023 and the processing unit 1024, wherein the processing unit 1024 is optional.

The hardware protocol engine 1023 implements a link layer of the interconnection protocol. The link layer can be implemented according to a modified version of UniPro as exemplified above. The hardware protocol engine 1023 communicates with the device interface 1021 and the processing unit 1024 and performs data conversion according to the specification of the link layer. In addition, the hardware protocol engine 1023 (or the device controller 1022) can be regarded as an embodiment of the link controller 205 of the second device 20 shown in FIG. 1, or can be based on one or more of the embodiments of FIGS. 1-10B or related examples, whenever appropriate.

The processing unit 1024 is coupled to the hardware protocol engine 1023, and communicates with the host 1010 through the device interface 1021. The processing unit 1024 can execute one or more pieces of firmware. For example, the processing unit 1024 executes one or more pieces of firmware to communicate with the above flash memory controller, so as to exchange data such as an access operation command, write data or read data between the interconnection protocol and the flash memory controller. The firmware can be stored, for example, in an internal memory of the processing unit 1024, an internal memory of the device controller 1022, or a predetermined storage region of the storage module 1026, wherein the internal memory can include a volatile memory and a non-volatile memory.

As shown in FIG. 11A, the host interface 1011 can be coupled to the device interface 1021, for example, through data lines Din and Dout for transmitting or receiving data, a reset line RST for transmitting a hardware reset signal, and a clock line CLK for transmitting a clock signal. The data lines Din and Dout can be implemented in multiple pairs, wherein one pair of data lines Din or one pair of data lines Dout can be referred to as a lane for transmitting differential signals, for example. The host interface 1011 can communicate with the device interface 1021 by using at least one interface protocol; however, the implementation of the disclosure is not limited to the examples above.

A modified version of the UFS standard is taken as an example of the interconnection protocol. The UFS standard includes a UFS command set (UCS) layer, a UFS transport (UTP) layer, and a UFS interconnect (UIC) layer. The UIC layer includes a link layer and a physical layer. In the interconnection protocol, the link layer of the UIC layer can be implemented according to a modified version of the UniPro specification, and the physical layer of the UIC layer can be implemented according to a modified version of the M-PHY specification.

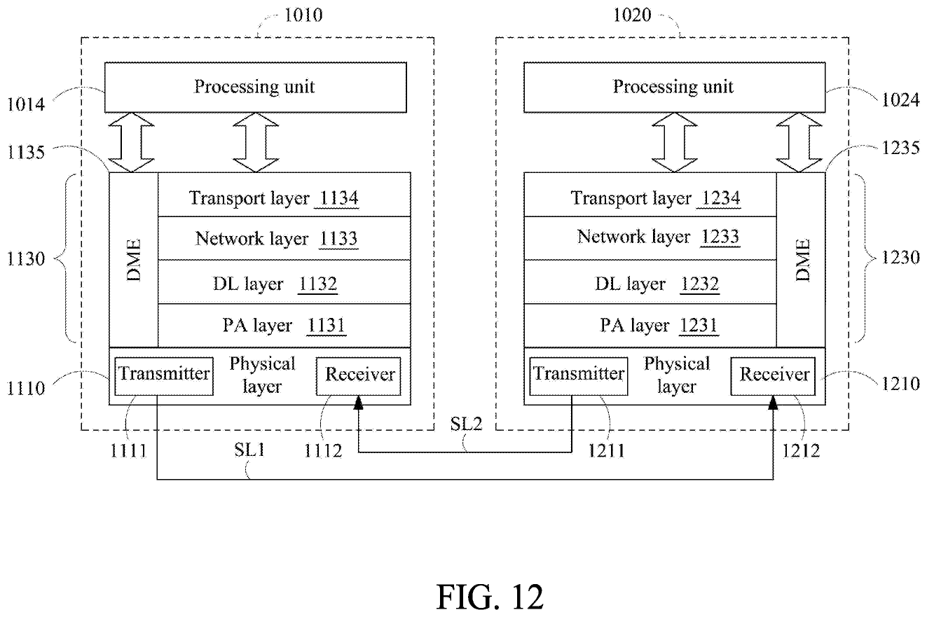

Referring to FIG. 12, a schematic diagram of layered architecture of the storage system in FIG. 11A is shown according to the UFS standard. Because the UFS standard is based on the MIPI UniPro layer and the MIPI M-PHY layer, the host interface 1011 and the hardware protocol engine 1013 of the host 1010 shown in FIG. 11A are respectively used to implement a modified physical layer 1110 and a modified UniPro layer 1130 in FIG. 12. Also, the device interface 1021 and the hardware protocol engine 1023 of the storage device 1020 in FIG. 11A are respectively used to implement a modified physical layer 1210 and a modified UniPro layer 1230 in FIG. 12. In addition, one or more of the embodiments of FIGS. 1-4, 7, 10A-10B or related examples regarding cross layer architecture, whenever appropriate, can be applied to the layered architecture of FIG. 12.

As shown in FIG. 12, the modified UniPro layer 1130 (or 1230) can include a modified physical adapter (PA) layer 1131 (or 1231), a data link (DL) layer 1132 (or 1232), a network layer 1133 (or 1233), and a transport layer 134 (or 1234). The layers in the modified UniPro layer 1230 of the storage device 1020 can also similarly operate and be implemented.

The modified physical adapter layer (1131 or 1231) couples the modified physical layer (1110 or 1210) to the data link layer (1132 or 1232). The modified physical adapter layer (1131 or 1231) is capable of performing bandwidth control and power management between the modified physical layer (1110 or 1210) and the data link layer (1132 or 1232). In practice, the modified physical layer 1110 of the host 1010 includes a transmitter (TX) 1111 and a receiver (RX) 1112, and the modified physical layer 1210 of the storage device 1020 includes a transmitter (TX) 1211 and a receiver (RX) 1212, thereby establishing data lanes SL1 and SL2 to perform full duplex communication. The modified UniPro specification may support multiple data lanes for a link in each transmission direction (for example, forward or backward).

The data link layer (1132 or 1232) is capable of performing flow control of data transmission between the host 1010 and the storage device 1020. The data link layer is capable of performing error detection and re-transmission of a frame in case of errors, according to one or more of the embodiments above.

The network layer (1133 or 1233) is used to select a routing function for a transmission path for the packets received from the transport layer (1134 or 1234).

The transport layer (1134 or 1234) can use a command received from the UFS application layer to configure a data segment suitable for the protocol and transmit the data segment to the network layer (1133 or 1233), or can extract a command from packets received from the network layer (1133 or 1233) and transmit the command to the UFS application layer.

Moreover, the modified UniPro layer (1130 or 1230) can be further implemented with a device management entity (DME) (1135 or 1235), which can communicate with the layers in the modified physical layer (1110 or 1210) and the modified UniPro layer (1130 or 1230), for example, the modified physical adapter layer (1131 or 1231), the data link layer (132 or 232), the network layer (1133 or 1233), and the transport layer (1134 or 1234), so as to communicate with the UFS application layer, thereby implementing the modified unified protocol (UniPro) overall functions such as control or configuration functions including power-on, power-off, reset, and power mode change.

Accordingly, one or more of the embodiments of FIGS. 1-4, 7, 10A-10B or related examples regarding the cross layer architecture can be applied to the embodiments of FIG. 11A, FIG. 11B, FIG. 11C, or FIG. 12 to perform operations according to one or more of the embodiments of FIG. 8, FIG. 9 or one or more related embodiments or examples, whenever appropriate.

In the present disclosure, “asserting” a signal (or other alternative forms such as “asserted” or “assertion”) means that a signal is set to be in an active state, which may be an active voltage level in a high or low level, or may be a signal in an associated form. “De-asserting” a signal (or other alternative forms such as “de-asserted” or “de-assertion”) means that a signal is set to be in an inactive state, which may be an inactive voltage level in a low or high level, or may be a signal in another associated form. If a signal is set to be at a low level to represent active-low, “asserting” the signal means that the signal is set to a low level, and “de-asserting” the signal means that the signal is set to a high level. If a signal is set to be at a high level to represent active-high, “asserting” a signal means that the signal is set to a high level, and “de-asserting” the signal means that the signal is set to a low level.

Moreover, in the embodiments related to the host and the storage device above, the hardware protocol engine in the host controller or the device controller can be designed based on Hardware Description Language (HDL) such as Verilog or techniques of any other design methods of digital circuits generally known to a person skilled in the art, and can be implemented by one or more of circuits based on such as a field programmable gate array (FPGA), an application-specific integrated circuit (ASIC), or a complex programmable logic device (CPLD), or be implemented by a dedicated circuit or module. The host controller or the device controller (or a processing unit or a hardware protocol engine therein) can also be based on a microcontroller, a processor, or a digital signal processor (DSP).

As described above, technologies for facilitating control frame transmission are provided, and are suitable for an electronic device capable of communicating with another electronic device according to an interconnection protocol. Embodiments of a device and a method for facilitating control frame transmission are provided. By using the technologies, control frame transmission can be performed more effectively and more efficiently, thereby reducing latency in control frame transmission and enhancing performance.

The present disclosure is described by using the embodiments above. A person skilled in the art should understand that, these embodiments are merely for describing the present disclosure are not to be construed as limitations to the scope of the present disclosure. It should be noted that all equivalent changes, replacements and substitutions made to the embodiments are to be encompassed within the scope of the present disclosure. Therefore, the scope of protection of the present disclosure should be accorded with the broadest interpretation of the appended claims.

What is claimed is:

1. An electronic device configured to facilitate control frame transmission, the electronic device comprising:
an interconnection controller including:
a physical layer circuit for signal transmission;
a signaling interface;
a link controller coupled to the physical layer circuit through the signaling interface; and
a bypass path coupled to the link controller for control frame transmission,
wherein the link controller is configured to transmit data to the physical layer circuit through the signaling interface, and to transmit a control frame to the physical layer circuit through a signal path including the bypass path to bypass at least one circuit stage of the link controller.

2. The electronic device according to claim 1, wherein the bypass path serves as the signal path and is connected between a circuit stage of the link controller and the physical layer circuit.

3. The electronic device according to claim 2, wherein the link controller is configured to transmit the control frame directly from a pipelined circuit of the link controller to the physical layer circuit through the bypass path to bypass at least one circuit stage between the pipelined circuit of the link controller and the physical layer circuit.

4. The electronic device according to claim 2, wherein the link controller is configured to transmit the control frame directly from a data link layer of the link controller to the physical layer circuit through the bypass path.

5. The electronic device according to claim 2, wherein the link controller is configured to transmit the control frame directly to the physical layer circuit through the bypass path to bypass a physical adapter layer of the link controller.

6. The electronic device according to claim 2, wherein the link controller is configured to transmit the control frame to the physical layer circuit directly through the bypass path, and the physical layer circuit is configured to, in response to the control frame, transmit a control information signal based on the control frame and pause signal transmission which is based on the data received through the signaling interface.

7. The electronic device according to claim 6, wherein the physical layer circuit is configured to transmit the control information signal based on the control frame and pause the signal transmission which is based on the data received through the signaling interface in response a control signal associated with the control frame received through the bypass path.

8. The electronic device according to claim 6, wherein the physical layer circuit is configured to proceed with the signal transmission which is based on the data received through the signaling interface after transmitting the control information signal based on the control frame.

9. The electronic device according to claim 6, wherein the control information signal includes information based on the control frame and information based on a control symbol of continuation of preempted frame (COF).

10. The electronic device according to claim 1, wherein the bypass path is coupled between a circuit stage of the link controller and the signaling interface, and the signal path includes the bypass path and the signaling interface.

11. The electronic device according to claim 10, wherein the link controller is configured to transmit the control frame from a pipelined circuit of the link controller to the physical layer circuit through the signal path including the bypass path and the signaling interface to bypass at least one circuit stage between the pipelined circuit of the link controller and the signaling interface.

12. The electronic device according to claim 10, wherein the bypass path is connected between a data link layer of the link controller and an interfacing module of a physical adapter layer of the link controller, and the interfacing module is connected to the signaling interface.

13. The electronic device according to claim 10, wherein the link controller is configured to transmit the control frame from the data link layer of the link controller to the physical layer circuit through the signal path including the bypass path and the signaling interface.

14. The electronic device according to claim 10, wherein the link controller is configured to transmit the control frame to the physical layer circuit through the signal path including the bypass path and the signaling interface to bypass a physical adapter layer entity of a physical adapter layer of the link controller.

15. The electronic device according to claim 1, wherein the control frame is an acknowledgment and flow control (AFC) frame or a negative acknowledgment control (NAC) frame based on a Unified protocol (UniPro).

16. A method for facilitating control frame transmission for use in an electronic device, the method comprising:
transmitting data from a link controller of the electronic device to a physical layer circuit of the electronic device through a signaling interface; and
transmitting a control frame from the link controller to the physical layer circuit through a signal path including a bypass path coupled to the link controller for control frame transmission to bypass at least one circuit stage of the link controller.

17. The method according to claim 16, wherein the control frame is transmitted from the link controller to a physical layer circuit directly through the bypass path serving as the signal path to bypass a physical adapter layer of the link controller.

18. The method according to claim 16, wherein the method further comprises:
in response to the control frame, transmitting, by the physical layer circuit, a control information signal based on the control frame and pausing signal transmission which is based on the data received through the signaling interface.

19. The method according to claim 18, wherein the method further comprises:
proceeding with the signal transmission which is based on the data received through the signaling interface after transmitting the control information signal based on the control frame.

20. The method according to claim 16, wherein the control frame is transmitted from the link controller to the physical layer circuit through the signal path including the bypass path and the signaling interface to bypass at least one circuit stage between a pipelined circuit of the link controller and the signaling interface.
